(19) United States
(12) Patent Application Publication
(10) Pub. No.: US 2009/0322296 A1
(43) Pub. Date: Dec. 31, 2009

(54) Multi-chip module for power supply circuitry

(76) Inventors: Chung-Shu Li, Yonghe City (TW); Chia-Jung Lee, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/457,666

(22) Filed: Jun. 18, 2009

(30) Foreign Application Priority Data
Jun. 20, 2008 (TW) 097123136

(51) Int. Cl. G05F 1/00

(52) U.S. Cl. 323/282; 327/530

(57) ABSTRACT

A multi-chip module (MCM) for power supply circuitry integrates a controller, a driver and two power MOSFETs in a single chip to shorten the signal path between the controller and the driver. When applied to a voltage regulator, the MCM shortens the feedback paths between the current sensors and the controller, so as to reduce the loss of and interference with the feedback signals, thereby improving the efficiency of the voltage regulator and simplifying the PCB traces routing.

### FIELD OF THE INVENTION

The present invention relates to low-voltage, high-current voltage regulator applications which use multi-channel buck converters. More specifically, the present invention relates to a multi-chip module (MCM) which combines a controller, a driver and two MOSFETs for a multi-channel buck converter to improve response performance during load transient and efficiency.

### BACKGROUND OF THE INVENTION

The circuitry of low-voltage, high-current voltage regulator applications using multi-channel buck converters has substantial area on printed circuit boards (PCBs). It is agreeable to improve the converter efficiency by reducing the power losses due to the parasitic components present in the layout path and the noise susceptible traces on the PCBs.

Based on the Intel Platform Layout Requirements for CPU power supply, some stages of a multiphase voltage regulator are placed away from the PWM controller as shown in FIG. 1. In this partial layout of a motherboard, the voltage regulator has four channels, and in order to facilitate explanation, the southbridge chip, northbridge chip and CPU chip 18 are designated by numerals 12, 14 and 18 on a PCB 10. The controller of the voltage regulator is arranged at the position 16 below the CPU chip 18, and the four channels are distributed from the controller's position 16 to the north. More specifically, the channels 1 and 2 are located at the position 20 near and to the east of the CPU's position 18, and the other channels 3 and 4 are located at the position 22 to the north of the CPU's position 18. In this layout, the feedback traces from the channels 3 and 4 to the controller will go through over half of the PCB 10 and thus have quite long paths. If more channels are included in a voltage regulator, the feedback traces will go through across the entire PCB 10 and have even longer paths.

MCM is an electronic package which includes several integrated circuits (ICs) placed on a common substrate and mutually isolated by insulator, and an encapsulant to encapsulate the whole module. U.S. Pat. No. 6,879,491 to Jauregui eliminates the PCB traces between one driver and two MOSFETs by integrating the driver and MOSFETs into a MCM package. However, there is no help for minimizing the signal paths between the controller and drivers of a voltage regulator. Referring to FIG. 2 for further details, a voltage regulator includes plural MCMs 22, each combining a driver and two MOSFETs and called a DrMOS, and a controller 24 to provide pulse width modulation signals PWM1 to PWMN to the MCMs 22 to control the drivers in the MCMs 22 to drive the MOSFETs. Since one driver and two MOSFETs are packaged into a single chip 22, the signal loss and interference that might otherwise occur along the signal paths therebetween are eliminated. However, for the controller 24 to obtain the feedback signals from the current sensors (CSs) 26, two traces 28 and 30 are required for each channel to deliver the current sense signals. Consequently, a voltage regulator having N channels needs 2×N traces to deliver the current sense signals as the feedback signals to the controller 24. As a result, the current sense signals suffer from signal loss and noise interference along the long physical paths defined by these traces 28 and 30 on the PCB. Moreover, these traces 28 and 30 may cause difficulty in traces routing between the controller 24 and current sensors 26 on the PCB.

### SUMMARY OF THE INVENTION

An object of the present invention is to provide a multi-chip module for power supply circuitry.

Another object of the present invention is to shorten the PCB traces of a voltage regulator.

A further object of the present invention is to improve the efficiency of a voltage regulator.

Still another object of the present invention is to reduce the power loss of a voltage regulator.

Yet another object of the present invention is to reduce the noise interference of a voltage regulator.

According to the present invention, an MCM for power supply circuitry comprises a controller, a driver and two MOSFETs integrated in a single module to shorten the feedback paths between each of the channels and the controller, thereby reducing the signal loss and interference, and in turn improving the efficiency of the converter.

Preferably, the MCM further comprises an internal current sensor to detect the channel current to provide a current sense signal to the controller.

Preferably, the internal current sensor detects the current in one of the two MOSFETs to provide the current sense signal to the controller.

According to the present invention, a voltage regulator comprises a plurality of channels connected in parallel between a power input and a power output, each including an MCM and an inductor connected in series between the power input and the power output. The MCM comprises a controller, a driver and two MOSFETs, and the controller provides an internal PWM signal to the driver to switch the two MOSFETs.

In one embodiment of the present invention, each of the channels further comprises an external current sensor to detect the inductor current of this channel, to provide a feedback signal to the MCM of this channel.

In another embodiment of the present invention, the MCM of each of the channels further comprises an internal current sensor to detect the inductor current of this channel, to provide a feedback signal to the controller of this channel.

Preferably, a reference current generator is provided to supply a reference current signal to each of the MCMs to balance the inductor currents of the channels.

In one embodiment of the present invention, the voltage regulator further comprises an external current sensor to detect the total current of the channels at the power output, to provide a total current signal to the reference current generator to generate the reference current signal accordingly.

In another embodiment of the present invention, the reference current generator generates the reference current signal from the inductor currents of the channels.

By eliminating the parasitic elements between the current sensor, the controller, and the power switches, the present invention reduces the converter loss. In addition, by placing the current sensor close to the controller, the noise along the feedback paths is reduced and the PCB traces routing is simplified.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a diagram showing the partial layout of a motherboard;

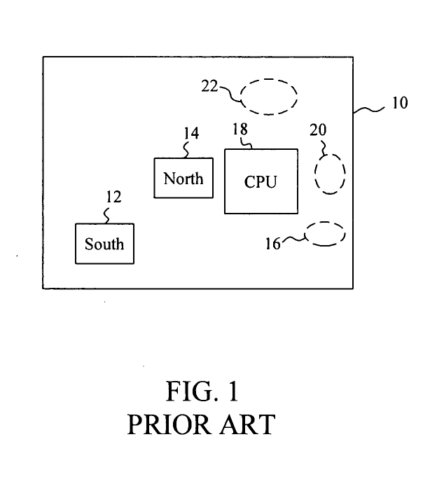

FIG. 2 is a circuit diagram showing a conventional voltage regulator;

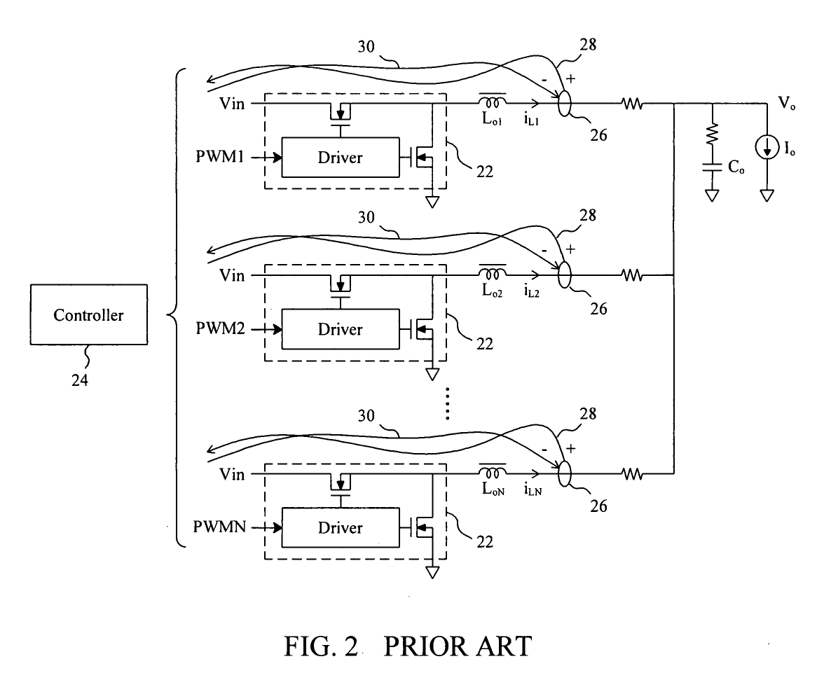

FIG. 3 is a circuit diagram showing an MCM according to the present invention;

FIG. 4 is a partial circuit diagram of a voltage regulator according to a first embodiment of the present invention;

FIG. 5 is a partial circuit diagram of a voltage regulator according to a second embodiment of the present invention;

FIG. 6 is a partial circuit diagram of a voltage regulator according to a third embodiment of the present invention;

FIG. 7 is a partial circuit diagram of a voltage regulator according to a fourth embodiment of the present invention;

FIG. 8 is a partial circuit diagram of a voltage regulator according to a fifth embodiment of the present invention; and

FIG. 9 is a partial circuit diagram of a voltage regulator according to a sixth embodiment of the present invention.

### DETAILED DESCRIPTION OF THE INVENTION

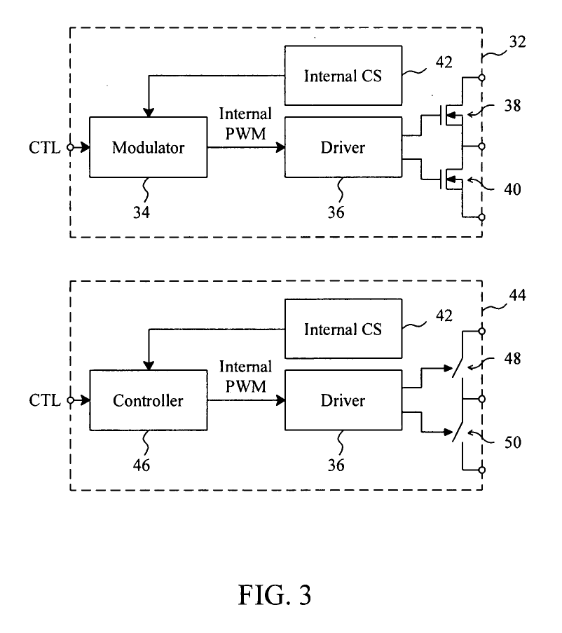

FIG. 3 shows an embodiment according to the present invention, in which an MCM 32 combines a modulator 34, a driver 36 and two power MOSFETs 38 and 40 in a single chip. The modulator 34 generates an internal PWM signal to the driver 36 according to an external control signal CTL to switch the MOSFETs 38 and 40. The external control signal CTL may include a current signal, a voltage signal and others such as a reference current signal, an output voltage feedback signal, an external PWM signal, and so on, depending on the demands in practical applications. As known in the art, the modulator 34, the driver 36 and the MOSFETs 38 and 40 are all bounded on an MCM package substrate (not shown). Based on practical circuit planning, a current sense function may be also integrated in the MCM 32, for example, by incorporating an internal current sensor 42 shown in FIG. 3. In this disclosure, the term “internal” indicates “inside an MCM” while the term “external” indicates “outside an MCM”. In many applications, as shown in the MCM 44 in the lower portion of FIG. 3, a controller 46 represents a control circuit including a modulator and sometimes is also known as a PWM controller, and power switches 48 and 50 are MOSFETs or other switching elements. In the following description, without departing from the generality principle, the controller 46 is used to refer to a circuit which provides the internal PWM signal to the driver 36.

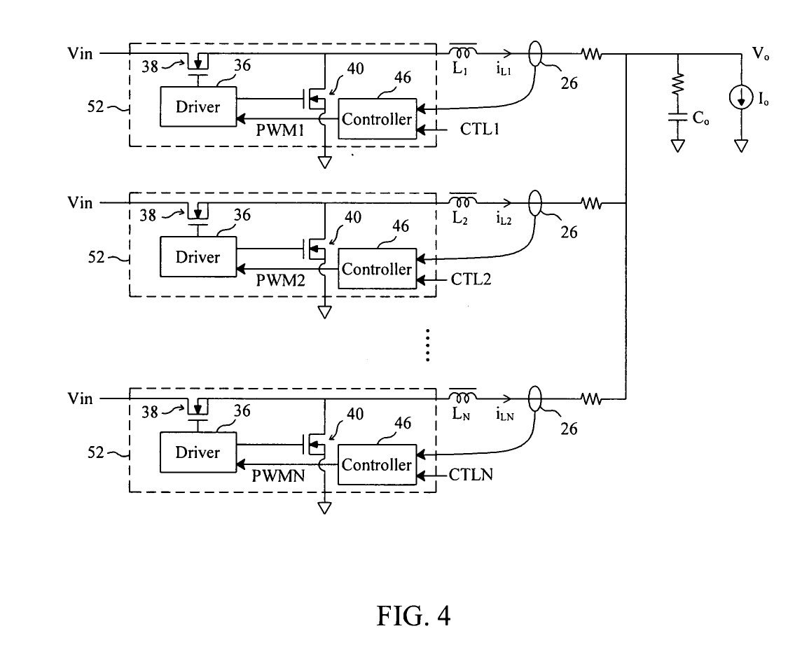

FIG. 4 is a partial circuit diagram of a voltage regulator according to one embodiment of the present invention, in which a plurality of channels are connected in parallel between a power input Vin and a power output Vo, each including an MCM 52 and an inductor Lⱼ (j=1,2, . . . ,N) connected in series between the power input Vin and the power output Vo. The MCM 52 is integrated therein with a controller 46, a driver 36 and two power MOSFETs 38 and 40. Each channel uses an external current sensor 26 to detect the inductor current i_{Lj} (j=1,2, . . . ,N) to provide a feedback signal to the controller 46 of this channel. In each channel, the MCM 52 uses its own controller 46 to generate an internal PWM signal PWMj (j=1,2, . . . ,N) to its own driver 36, to control the inductor current i_{Lj} of this channel. Since the controller 46 and the driver 36 are integrated in the MCM 52, the signal path therebetween is very short. Furthermore, the controller 46 may be arranged close to the external current sensor 26 so that the feedback path is also very short.

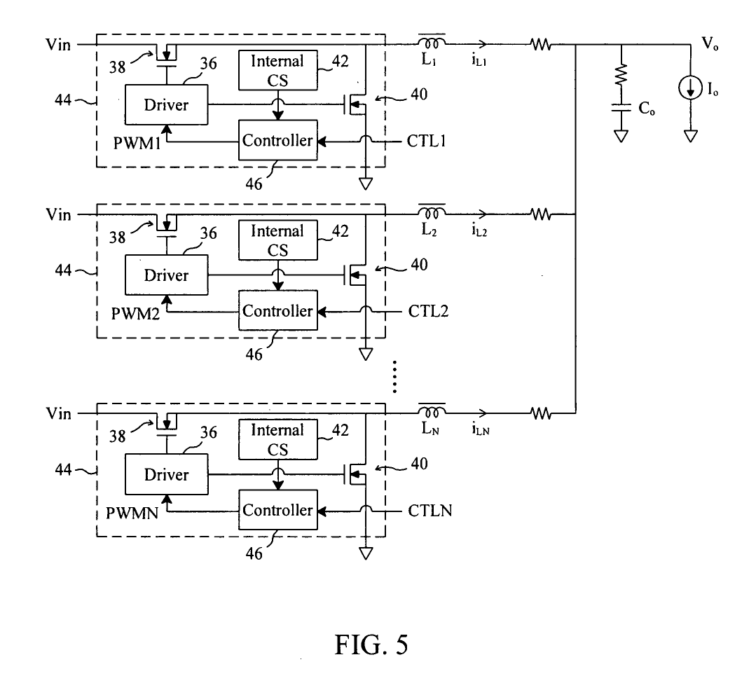

FIG. 5 is a partial circuit diagram of a voltage regulator using the MCM 44 of FIG. 3. In this embodiment, not using external current sensors to detect the inductor currents i_{L1}-i_{LN}, the feedback signals are provided by internal current sensors 42 instead, and thus have shorter feedback path than that of FIG. 4. The internal current sensor 42 may detect the current in either one of the MOSFETs 38 and 40 or other signals, to generate the feedback signal related to the inductor current of its channel.

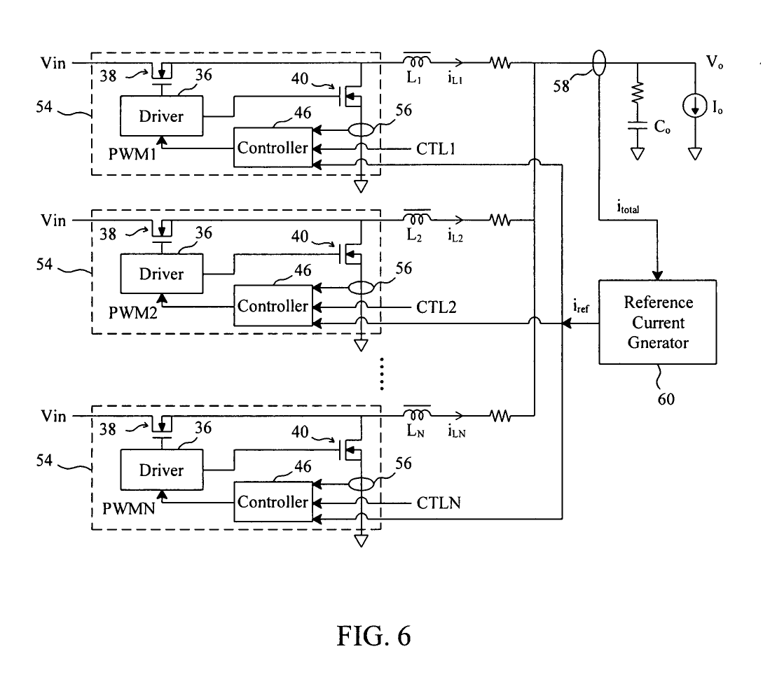

In some embodiments, as shown in FIG. 6, the internal current sensor 56 in the MCM 54 detects the current iⱼ (j=1,2, . . . ,N) in the MOSFET 40 in the same MCM 54, but not directly detects the inductor current i_{Lj} (j=1,2, . . . ,N) of this channel. Moreover, an external current sensor 58 detects the total current at the power output Vo to generate a total current signal iₜₒₜₐₗ, and a reference current generator 60 generates a reference current signal i_{ref} from the total current signal iₜₒₜₐₗ to supply to each of the MCMs 54. In each channel, the controller 46 generates an internal PWM signal according to the feedback signal from the internal current sensor 56 and the reference current signal i_{ref} from the reference current generator 60 for the driver 36. By feeding back the reference current signal i_{ref} to each channel, the inductor currents i_{L1}-i_{LN} of the channels could be balanced to eliminate the non-ideal effects caused by element differences between the channels. The reference current generator 60 is placed near the power output Vo, thereby simplifying the PCB traces routing.

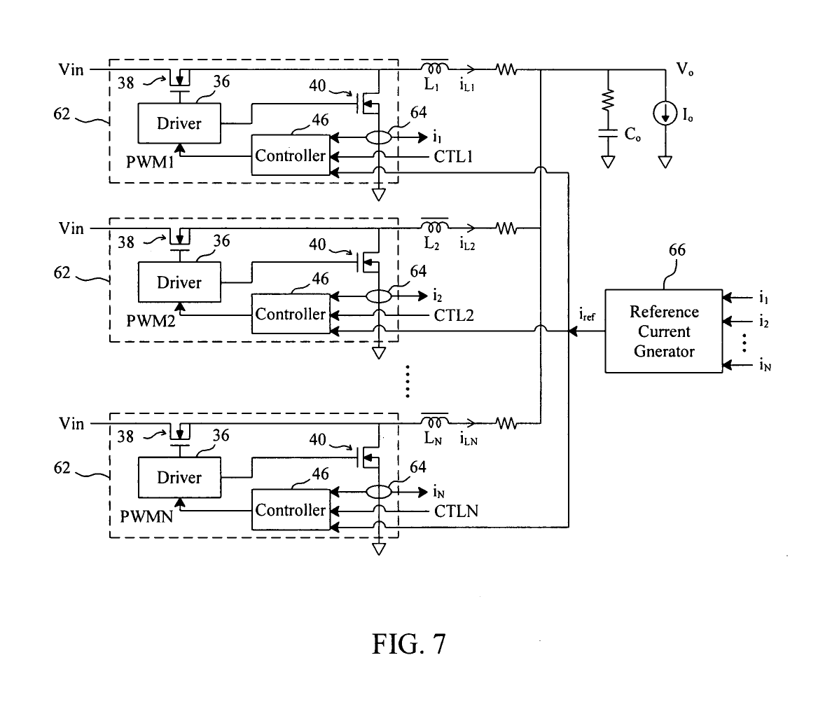

FIG. 7 is a diagram showing an alternative embodiment, in which the signal iⱼ (j=1,2, . . . ,N) generated by detecting the current in the MOSFET 40 by the internal current sensor 64 to feed back to the controller 46 is also sent out to a reference current generator 66 to generate a reference current signal i_{ref} for the controller 46 in each MCM 62.

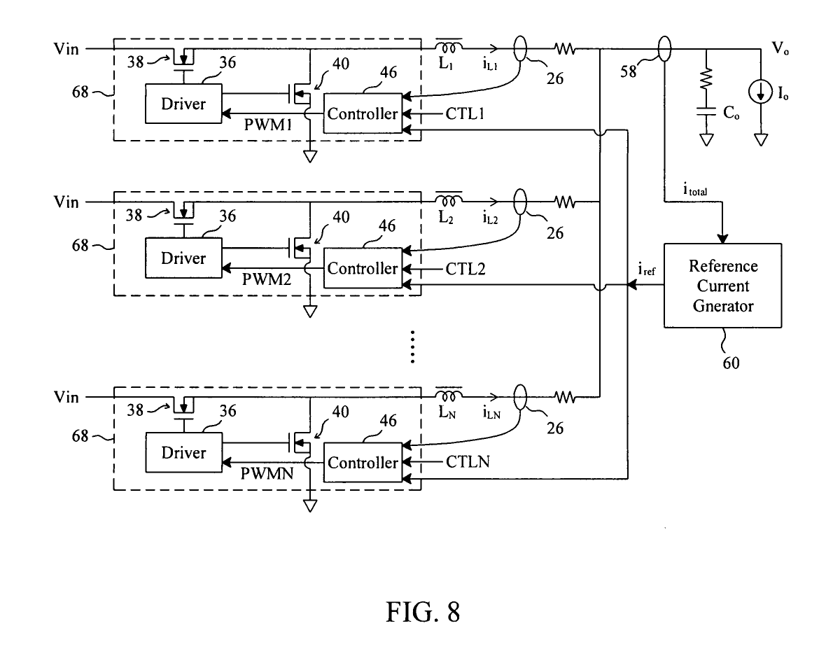

FIG. 8 is a diagram showing a modified embodiment from that of FIG. 4, in which the external current sensor 58 detects the total current, and the reference current generator 60 generates the reference current signal i_{ref} from the total current signal iₜₒₜₐₗ, to supply to the controllers 46 of the channels to balance the inductor currents i_{L1}-i_{LN} of the channels.

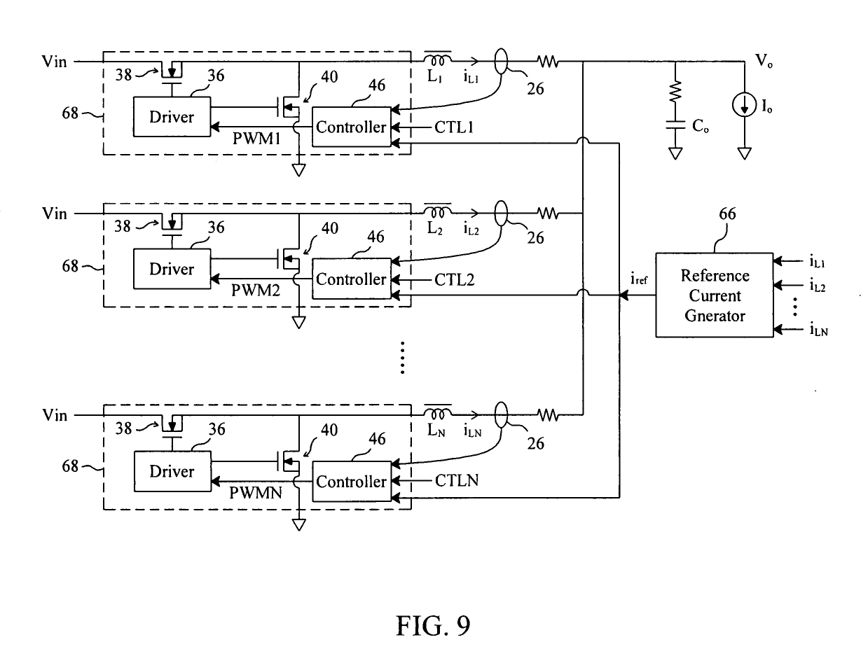

FIG. 9 is a diagram showing a modified embodiment from that of FIG. 8, in which the reference current generator 66 generates the reference current signal i_{ref} from the inductor currents i_{L1}-i_{LN} of the channels, to supply to each MCM 68 to balance the inductor currents i_{L1}-i_{LN} of the channels.

The MCM of the present intention, by integrating a controller, a driver, and two MOSFETs in a single chip, eliminates PCB traces between the controller and the driver and shortens the signal paths between the current sensors and the controller, thus reducing power loss and noise interference. Meantime, the MCM of the present intention also simplifies PCB routing.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A multi-chip module for power supply circuitry, comprising:
two MOSFETs, each having a gate;
a driver connected to the two gates; and
a controller connected to the driver, operative to provide an internal PWM signal to the driver.

2. The multi-chip module of claim 1, further comprising an internal current sensor connected to the controller, operative to provide a feedback signal to the controller.

3. The multi-chip module of claim 2, wherein the internal current sensor is connected to one of the two MOSFETs and detects a current therein to generate the feedback signal.

4. The multi-chip module of claim 2, wherein the controller determines the internal PWM signal according to the feedback signal and an external reference current signal.

5. A voltage regulator, comprising:
a plurality of channels connected in parallel between a power input and a power output, each including:
an inductor connected between the power input and the power output;
a multi-chip module connected between the power input and the inductor, comprising:
two serially connected MOSFETs, each having a gate;
a driver connected to the two gates; and
a controller connected to the driver, operative to provide an internal PWM signal to the driver; and
an external current sensor connected to the multi-chip module and the inductor, operative to detect the current in the inductor to provide a feedback signal to the multi-chip module;
wherein the controller switches the two MOSFETs according to the internal PWM signal, to control the current in the inductor.

6. The voltage regulator of claim 5, further comprising:
A second external current sensor connected to the power output, operative to detect the total current of the plurality of channels to generate a total current signal; and
a reference current generator connected to the second external current sensor, operative to generate a reference current signal from the total current signal, to supply to each of the multi-chip modules.

7. The voltage regulator of claim 5, further comprising a reference current generator connected to each of the external current sensors, operative to generate a reference current signal from the feedback signals, to supply to each of the multi-chip modules.

8. A voltage regulator, comprising:
a plurality of channels connected in parallel between a power input and a power output, each including:
an inductor connected between the power input and the power output;
a multi-chip module connected between the power input and the inductor, comprising:
two serially connected MOSFETs, each having a gate;
a driver connected to the two gates;
a controller connected to the driver, operative to provide an internal PWM signal to the driver; and
an internal current sensor connected to the controller, operative to provide a feedback signal representative of the current in the inductor for the controller;
wherein the controller switches the two MOSFETs according to the internal PWM signal, provided thereby to, to control the current in the inductor.

9. The voltage regulator of claim 8, wherein each of the internal current sensors is connected to one of the two MOSFETs within the multi-chip module where it is, operative to detect the current in the one of the two MOSFETs to generate the feedback signal it provides.

10. The voltage regulator of claim 8, further comprising:
an external current sensor connected to the power output, operative to detect the total current of the plurality of channels to generate a total current signal; and
a reference current generator connected to the external current sensor, operative to generate a reference current signal from the total current signal, to supply to each of the multi-chip modules.

11. The voltage regulator of claim 8, further comprising a reference current generator connected to each of the multi-chip modules, operative to generate a reference current signal from the feedback signals, to supply to each of the multi-chip modules.
